(19) United States
(12) Patent Application Publication
(10) Pub. No.: US 2011/0146583 A1
(43) Pub. Date: Jun. 23, 2011

(54) MODULAR PET ENCLOSURE AND KITS THEREOF

(76) Inventors: ERIK N. LARSON, CARLSBAD, CA (US); THOMAS L. NELSON, ENCINITAS, CA (US); JAMES E. KOCHER, HALEIWA, HI (US); TAYLOR E. MATTHEWS, SAN DIEGO, CA (US)

(21) Appl. No.: 12/974,823

(22) Filed: Dec. 21, 2010

Related U.S. Application Data
(60) Provisional application No. 61/289,907, filed on Dec. 23, 2009.

(51) Int. Cl. A01K 1/03

(52) U.S. Cl. 119/455; 119/473; 119/481; 119/500

(57) ABSTRACT

A modular pet enclosure having interchangeable and configurable wall panels of varying size is provided. The tunnel connection panel can be placed in multiple different configurations and orientations. An open-ended tunnel that can be removably attached to the modular pet enclosure and a dwelling, including all known pet doors, is used for the pet to move between the dwelling and the enclosure.

### CROSS REFERENCES

This application claims priority from U.S. Provisional Patent Application Ser. No. 61/289,907 filed Dec. 23, 2009 incorporated herein in its entirety by this reference.

### BACKGROUND OF THE INVENTION

1. Field of the Invention

The present invention relates to the field of pet animal enclosures, and more particularly to a novel modular pet enclosure joined via a tunnel and a mounting flange to a dwelling using standard pet doors and other means, thereby permitting passage of the pet between the enclosure and dwelling, and to kits for easy assembly of the enclosure.

2. Description of the Prior Art

Numerous external structures or enclosures to contain and safeguard domestic pets, such as cats, dogs, rabbits and the like have been created. For example, see U.S. Pat. No. 4,021,975 (Calkins), U.S. Design Pat. No. D583,517 S (Tycer), U.S. Pat. No. 5,261,350 (Vavrek), U.S. Pat. No. 6,394,035 (Hill), U.S. Pat. No. 5,975,017 (Cameron) and U.S. Pat. No. 6,237,534 (Schwartz). Typically, pet owners employ these enclosures to, e.g., keep the litter box of the pet outside of the dwelling, thereby limiting odors, pet waste and excess litter within the dwelling, and to also safeguard the pet from abduction, injury, fights with other animals and extreme weather conditions when outside of the dwelling.

Many of these structures are of rigid construction and are difficult to adapt and attach to a dwelling. Likewise, this lack of adaptability and fixed structure make it difficult, if not impossible, to readily replace components of the structures as they wear or are otherwise damaged. Thus, a need exists for a modular and adaptable enclosure that can be configured in multiple variations by the pet owner and that is composed of modular components that can be readily replaced when desired, worn or damaged. Likewise, a need exists for a modular enclosure where the tunnel connecting the enclosure to the dwelling can be placed in multiple configurations and is readily adapted to fit any existing pet doors attached to the dwelling.

### BRIEF SUMMARY OF THE INVENTION

The present invention specifically addresses and alleviates the above mentioned deficiencies, more specifically, the present invention is directed to a modular pet enclosure, kit and methods wherein the enclosure is constructed of modular components and can be configured to meet the needs and desires of the user, including wall panels of different size, composition and configuration. In addition, the connection wall panel used for connecting the enclosure to a dwelling via a tunnel can be placed in any location of configuration as needed or desired. The base frame element, including channels in the upper and lower faces allow the panel support means to be located where desired and securely hold the panel support means and wall panels in place. Furthermore, the modular nature allows for larger enclosures to be formed by interconnecting one or more base frame elements side by side or by stacking one enclose on top of another to form a two, three or higher storied enclosure.

Accordingly, in a first aspect, the present invention provides a modular pet enclosure comprised of a base frame element with an upper and lower face both including one or more channels and further comprising a floor; a plurality of panel support means for containing a plurality of wall panels capable of being spaced at predetermined intervals and being held, at least in part, within the channels in the top face of the base frame element; a plurality of wall panels forming the sides of the enclosure, said wall panels being held in place by the panel support means and the channels in the upper face of the base frame element, wherein one of said wall panels comprises a tunnel connection panel, said tunnel connection panel including an opening and a connection flange surrounding said opening, said connection flange proving a base for the connection of a tunnel to the tunnel connection panel; a top frame element including an upper face, a lower face, sides and a channel along at least a portion or the lower face, said channel containing a top of each of the panel support means and wall panels, wherein one side of the upper face of the top frame element is higher than the opposing side, thereby creating a slant to the upper face of the top frame element; a roof element attached to and covering the upper face of the top frame element; an open-ended tunnel having a first end and a second end, said first end being attached to the connection flange of the tunnel connection panel and the second end being attached to a mounting flange, said dwelling flange being capable of attachment to an opening within the dwelling; and two or more adjustable legs attached to the lower face of the base frame element, said legs being adjustable in length to allow for the stable placement of the modular pet enclosure on the ground.

In a further aspect, the top frame element contains a plurality of ventilation openings to provide for ventilation air flow in the modular pet enclosure.

In another aspect, the wall panels are of differing size. Preferably, one or more of the wall panels includes an access door, said door being attached in a manner to open and close and further including a latch to maintain the door in a closed position.

In yet a further aspect, the roof element of the modular pet enclosure is attached to the top frame element with one or more means (e.g. hinges) to allow for the opening and closing of the roof and further including a locking mechanism intersecting with between the roof element and top frame element to securely maintain the roof element in a closed position relative to the top frame element.

In a further aspect the floor of the modular pet enclosure contains a plurality of openings to provide ventilation and air flow to the enclosure while at the same time maintaining and safely containing the pet within the enclosure. Preferably, the floor is comprised of a screen mesh or other modular floor with a plurality of patterned openings.

In yet a further aspect, the modular pet enclosure is capable of being expanded to fit the needs of the user. For example, two or more base frame elements can be connected end to end or side by side to form a larger expanded base frame. Likewise, one pet enclosure can be stacked on top of another where the wall panels of a first enclosure are inserted into the channels on the lower face of a second base frame element or a second enclosure, resulting, e.g., in a two storied modular pet enclosure.

In another aspect of the present invention, a method for attaching the modular pet enclosure of the present invention to a dwelling via an open-ended tunnel is provided by moving the modular pet enclosure to a predetermined orientation and location with respect to an opening in a residence; adapting the length and orientation of the open-ended tunnel as desired; and attaching the open end of a mounting flange affixed to a second end of the open-ended tunnel to the opening in the dwelling.

Furthermore, the present invention provides a kit for assembling a modular pet enclosure according to the present invention, where the kit is comprised of a base frame element, a floor, a plurality of panel support means, a plurality of wall panels, a tunnel connection panel, a top frame element, a roof element and a plurality of adjustable legs; an open-ended tunnel for connecting said enclosure to a dwelling opening; means for removably connecting a first end of the open-ended tunnel to an opening in the tunnel connection panel; and means for removably connecting a second end of the open-ended tunnel to and opening in the dwelling.

While the enclosures, methods and kit have or will be described for the sake of grammatical fluidity with functional explanations, it is to be expressly understood that the claims, unless expressly formulated under 35 USC 112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an isometric view of a preferred embodiment of the present invention;

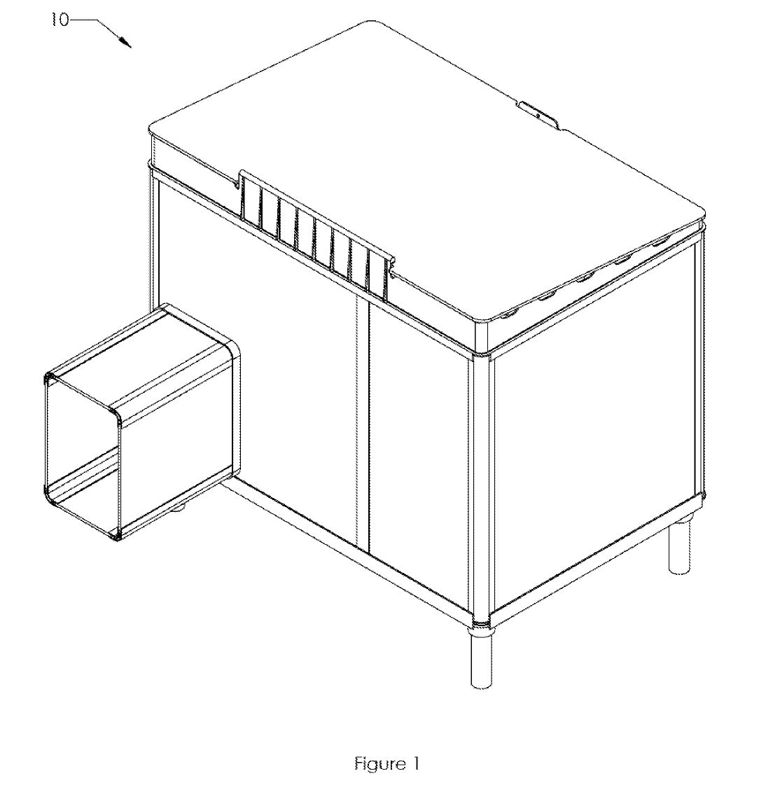

FIG. 2 is a side view of a preferred embodiment of the present invention;

FIG. 3 is a front view of a preferred embodiment of the present invention showing two different sized panels, one with optional access door;

FIG. 4 is a top view of a preferred embodiment of the present invention without the top frame element and roof element;

FIG. 5 is a cross-sectional view taken along a sectional line through a preferred embodiment of a modular pet enclosure according to the present invention;

FIG. 6 is a side view showing a preferred embodiment of the open-ended rigid tunnel of the present invention connected to pet door in an opening in a dwelling through a mounting flange according to an alternative embodiment of the present invention;

FIG. 7 is a front on view showing the open-ended tunnel of FIG. 6 of the present invention connected to pet door in an opening in a dwelling through a mounting flange according to an alternative embodiment of the present invention;

FIG. 8 is a cross sectional view of an embodiment of a rigid modular tunnel according to the present invention;

FIG. 9 is a top down view of an expanded modular pet enclosure according to the present invention showing two base frame elements interconnect end to end;

FIG. 10 is a side view of an expanded modular pet enclosure according to the present invention showing two pet enclosures stacked on top of each other to create the expanded enclosure; and

### DETAILED DESCRIPTION OF THE PREFERRED EMBODIMENTS

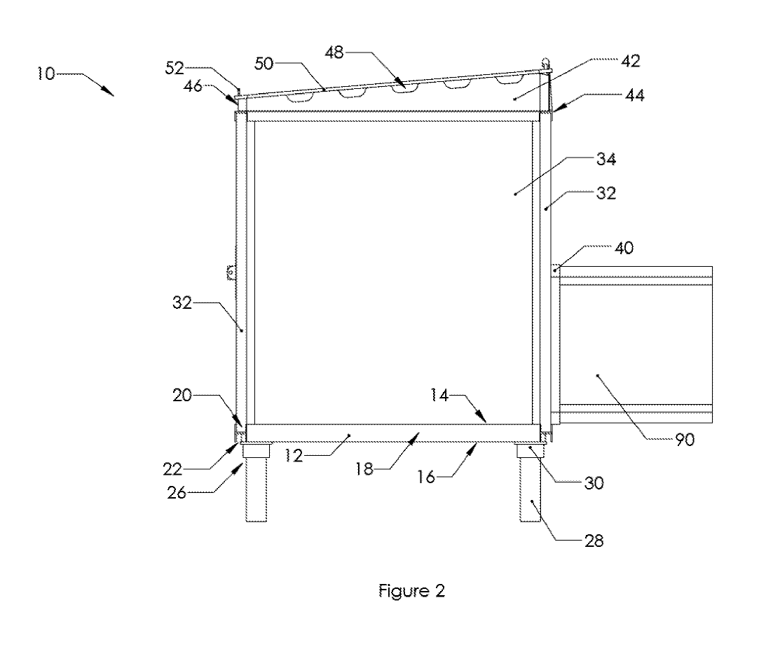

Referring initially to FIG. 2, illustrating a side view of a modular pet enclosure 10 according to the present invention comprised of a base frame element 12. The base frame element 12 has an upper face 14, lower face 16 and exterior side 18, also includes a first channel 20 in the upper face and second channel 22 in the lower face of the base frame element 12. The base frame element 12 further includes a floor 24 (not shown) comprised of or affixed within the base frame element 12. Several adjustable legs 26 are connected to the lower face 16 of the base frame element 12. Each of the adjustable legs 26 includes the leg 28 and adjustable locking ring 30.

The walls of the modular pet enclosure 10 are formed by numerous panel support means 32 which are spaced apart at a predetermined distance sufficient to allow for the inclusion of a number of wall panels 34. Each of the panel support means 32 and wall panels 34 are held securely within the channels 20 in the upper face 14 of the base frame element 12. In each pet enclosure 10, one of the wall panels 34 is comprised of a tunnel connection panel 36 (not shown) that is configured to accept the tunnel 90 used to connect the modular pet enclosure 10 to the dwelling. The tunnel 90 is removably affixed to the pet enclosure 10 using the connection flange 40 that is permanently attached and surrounds an access hole in the tunnel connection panel 36.

The top of the modular pet enclosure 10 is topped with a top frame element 42. The top frame element 42 includes a channel (not shown) on the lower face (not shown) of the top frame element 42. This channel securely holds and contains the top of the panel support means 32, wall panels 34 and tunnel connection panel 36 (not shown). Preferably, the top frame element 42 has a higher front face 44 than the back face 46, creating a slope from front to back, and include a plurality of ventilation openings 48 providing for ventilation and air flow within the modular pet enclosure 10. A roof element 50 is affixed to and covers the top frame element 42, providing a sloped roof to repel rain etc. The roof element 50 may also include a locking tab 52 extending through the roof element 50 from the top frame element 42, which stabilizes the roof element 50 and provides a potential point to lock the roof element 50 in a permanently closed position.

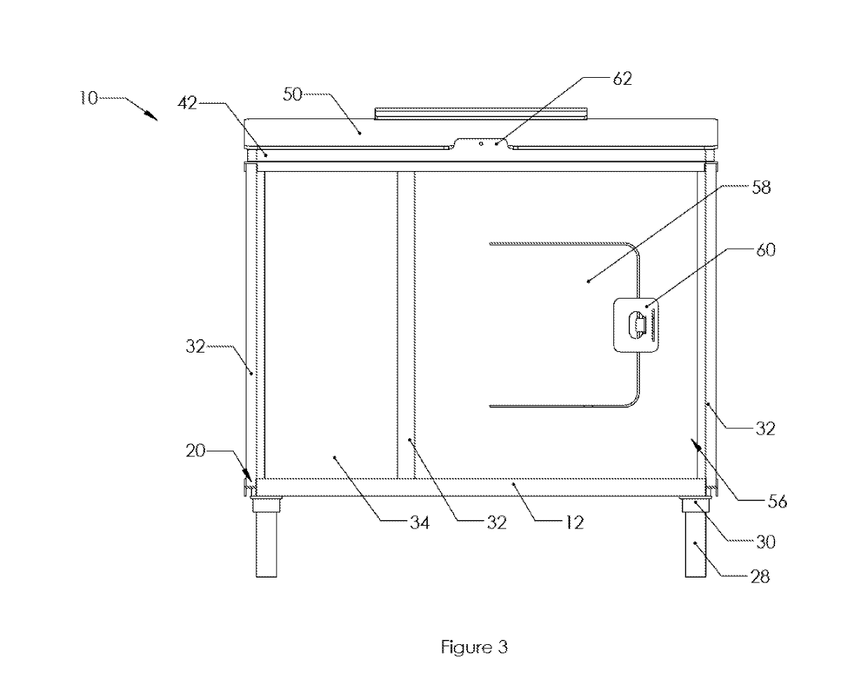

Referring now to FIG. 3, illustrating a front view of a modular pet enclosure 10 according to the present invention, wherein the legs 28 of the enclosure have been extended and locked in place with locking ring 30. In this embodiment, two regular wall panels 34 have been replaced by a double wide panel 56. Like the regular wall panels 34, the double wide panel 56 is held securely in place by the panel support means 32 and the channels 20 in the upper surface of the base frame element 12 and the channels in the lower surface (not shown) of the top frame element 42. The double wide panel 56 includes an optional access door 58 that is held securely in a closed position by door latch 60. In addition, roof element 50, includes a roof latch 62 that securely holds the roof 50 in a closed position. Both the access door 58 and roof element can be opened to provide ready access to the interior of the modular pet enclosure 10. In a preferred embodiment, both the access door 58 and roof element 50 are connected to the double wide panel 56 and top frame element 42, respectively, in a manner that allows for each opening and closing (e.g. with hinges, not shown), and can be securely locked in a closed position with door latch 60 and roof latch 62.

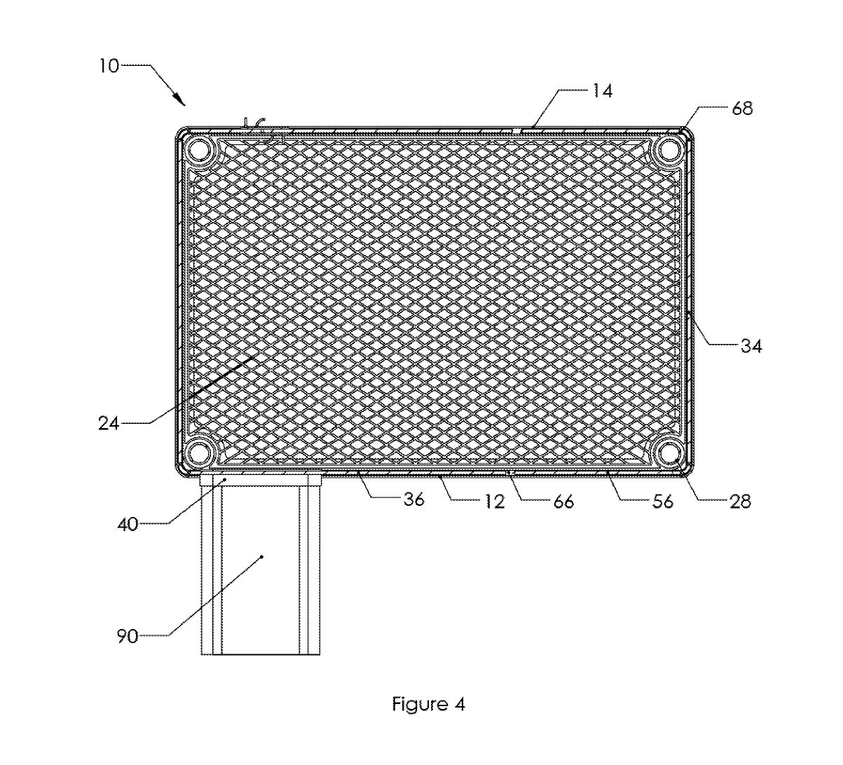

Referring now to FIG. 4 showing a top view of a preferred embodiment of the present invention without the top frame element 42 and roof element 50 attached. The base frame element 12 is supported by legs 28 and includes a mesh or screen floor 24 providing ventilation for the pet enclosure 10. The sides of the pet enclosure 10 are comprised of double wide panels 56 and regular wall panels 34, as well as tunnel connection panel 36 providing access to the enclosure from tunnel 90 attached to the tunnel connection panel 36 via connection flange 40. The various wall panels 34, 36, 56 are held in place with panel support means 32, here shown as H-channel elements 66 and L-channel elements 68, all of which are securely contained within the channels 20 (not shown) on the upper face 14 of the base frame element 12. Thus, a wall component, such as wall panel 34 is simply slid into the matching grooves of H-channel element 66 and another H-channel element 66 or on a corner, into the matching groove of an L-channel element 68. The wall panel 34 can then be secured within the channel 20 of the base frame element 12 using any conventional means, including through the use of tacks, glue, nails, screws, Velcro®-type connectors or the like. Importantly, the tunnel connection panel 36 can be placed in any position or configuration (up or down) substituting for a regular wall panel 34 in accordance with the invention. Accordingly, a user can place the tunnel as need to fit the placement and configuration of the pet enclosure 10 in connection with the dwelling.

The various components of the modular pet enclosure are preferably constructed of a durable, weather-resistant material. Such material preferably comprises wood, metal or plastic and is most preferably a plastic. In a preferred embodiment, the components are manufactured as extruded plastics, most preferably polymeric plastics such as polyurethane or polyethylene. By employing polymeric plastics, the walls of the pet enclosure 10 can be constructed of transparent, translucent, or opaque materials to control light penetration and viewing as needed. In an especially preferred embodiment, the components are extrusion formed as readily known in the art from UV, chemical resistant and environmentally compliant plastics such as Polygal®, IntePro®, or CoroPlast®.

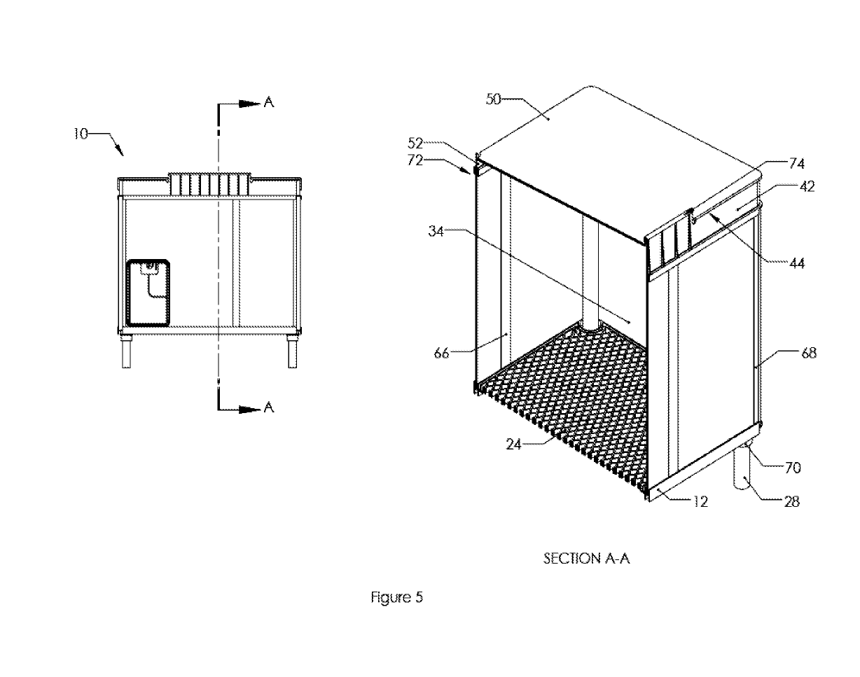

Referring now to FIG. 5, illustrating a cross-sectional view taken along a sectional line through a preferred embodiment of a modular pet enclosure 10 according to the present invention. The base frame element 12 includes a mesh floor 24 molded therein and telescoping, adjustable legs 28 extending through the floor 24 and held in firm alignment with stabilizing elements 70. The channels 20 in the base frame element 12 securely hold the bottom portions of wall panels 34, H-channel elements 66 and L-channel elements 68, while the tops of these same elements are also securely held in one of the top frame channels 72 in the lower face of the top frame element 42. The higher front face 44 of the top frame element 42 imparts a slant to roof element 50. The roof element 50, includes a stop fixture 74 attached to the top surface of the roof element 50, which prevents the roof element 50 from opening too far when lifted from front to back. The roof element 50 also includes a locking tab 52 extending through the roof element 50 from the top frame element 42, which stabilizes the roof element 50 and provides a potential point to lock the roof element 50 in a permanently closed position.

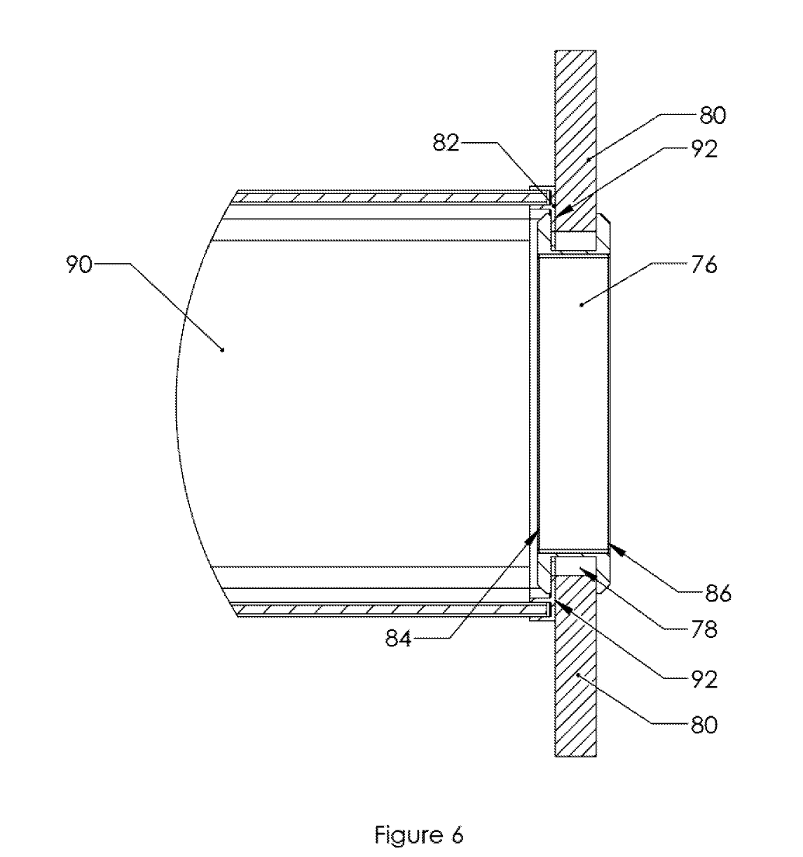

Referring now to FIG. 6, illustrating a side view of a preferred embodiment showing an open-ended rigid tunnel 90 of the present invention connected to pet door 76 in an opening 78 in a dwelling 80 through a mounting flange 82 according to the present invention. The mounting flange 82 extends around an outer frame 84 of pet door 76 and an inner portion 92 of mounting flange 82 is disposed behind the outer frame 84 of pet door 76. The outer frame 84 and inner frame 86 of pet door 76 are secured together using securing means extending through the opening 78 of pet door 76. The securing means are typically secured together with a screw (not shown) or other means such as a tack, glue, nail, Velcro®-type connectors or the like, thereby trapping and holding the inner portion 92 of mounting flange 82 behind the outer frame 84, which in turn maintains the rigid tunnel 90 securely affixed to the pet door 76 and dwelling 80. The mounting flange 82 of the present invention can interface with any pet doors on the market, whether in a sliding door, window, door or wall of a dwelling. Exemplary pet doors include Ideal Fast Fit Patio Panels ®, Ideal Patio Cat Panel®, Ideal Hefty Cat Patio Panel® and Petsafe® pet doors available from such vendors as www.petdoors.com and www.PetSmart.com.

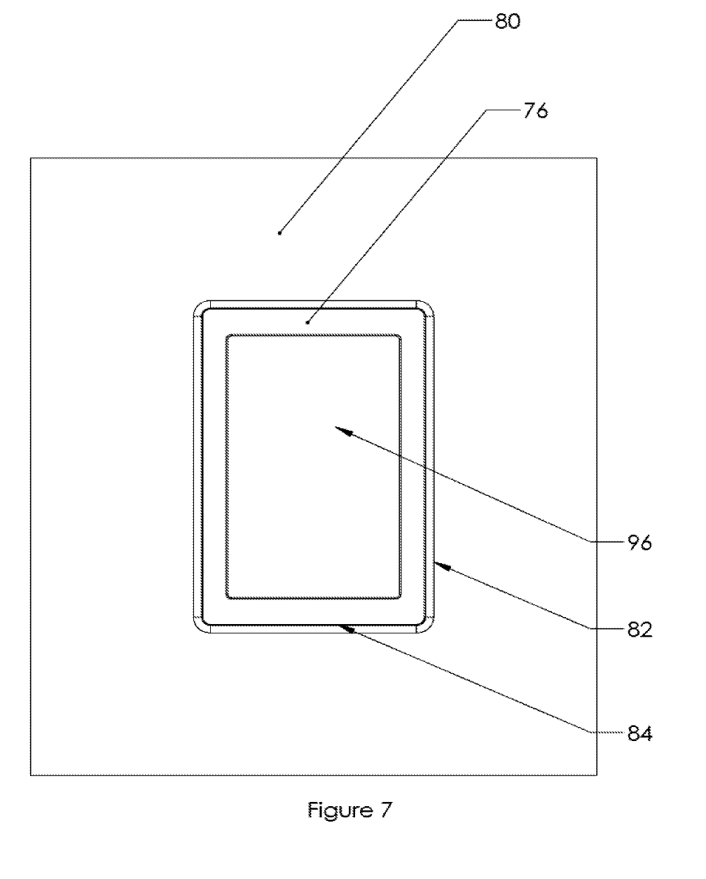

Referring now to FIG. 7, illustrating a front on view showing the open-ended rigid tunnel 90 of FIG. 6 of the present invention connected to pet door 76 in a dwelling 80 through a mounting flange 82 according to a preferred embodiment of the present invention. The rigid tunnel 90 (not shown) is connected to the dwelling 80 through mounting flange 82 which is securely held in place and connected to the pet door 76 and dwelling 80 using the outer frame 84 of pet door 76. Thus, the combination of the rigid tunnel 90 in connection to the pet door 76 in dwelling 80 allows the pet to have ingress and egress to the modular pet enclosure 10 through the typical opening 96 found in pet door 76.

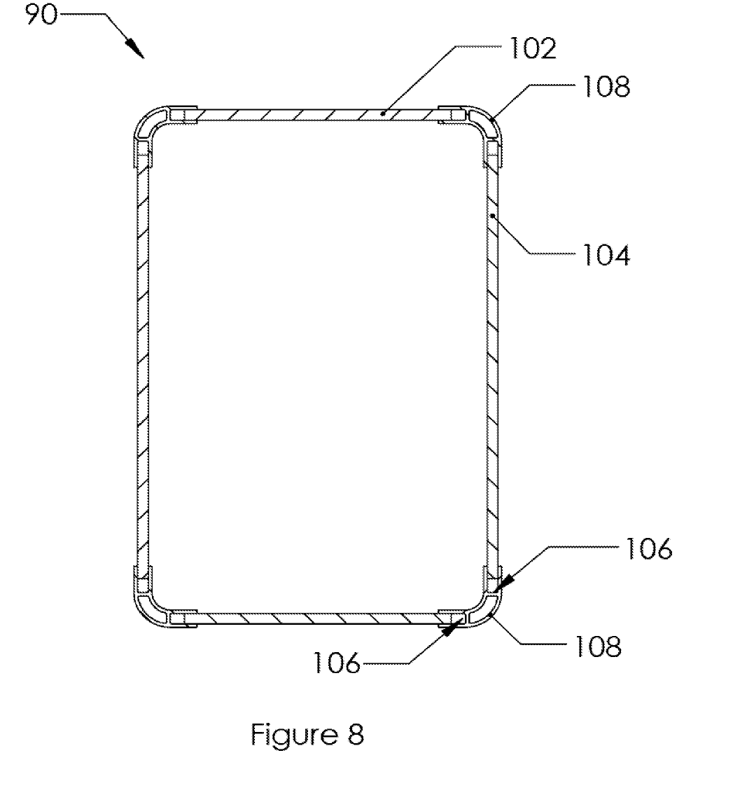

In an alternative embodiment, the open-ended rigid tunnel 90 may not be rigid but can be made of a flexible material, such as PVC ducting, for example, R-3®, Flexthane MD® or the like. In such an instance, the tunnel may utilize an optional adjustable tunnel support structure (not shown). In a preferred aspect, the open-ended tunnel 90 is a rigid tunnel, and the modular structure can be configured in straight or a 90 degree bends as needed by user during installation. In this regard, FIG. 8 is a cross sectional view of an embodiment of a rigid modular tunnel 90 according to the present invention. The rigid modular tunnel 90 is constructed of tunnel wall panels 102, 104, that can be the same or different widths. The tunnel wall panels 102, 104 are formed into a rectangular cross section and held in place by insertion in tunnel channels 106 of tunnel L-elements 108. Preferably, the tunnel walls 102, 104 and tunnel L-elements 108 are constructed of polymeric plastics, that may be transparent, translucent, or opaque materials to control light penetration and viewing as needed. In an especially preferred embodiment, the components are extrusion formed as readily known in the art from UV, chemical resistant and environmentally compliant plastics such as Polygal®, IntePro®, or CoroPlast®.

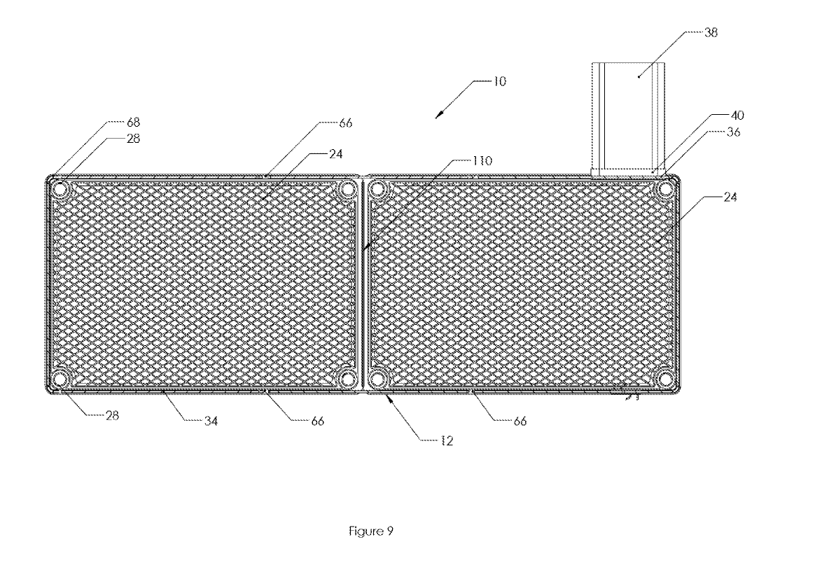

The modular pet enclosure 10 according to the invention can be expanded both in the size of the base as well as the height of the enclosure. For example, FIG. 9 shows a top down view of an expanded modular pet enclosure 10 according to the present invention showing two base frame elements 12 interconnected end to end. The two base frame elements 12 are interconnected with H-channel elements 66 at the boundary or intersection 110. No wall panels are placed in the intersection 110 creating twice the floor space for the pet enclosure of the present invention.

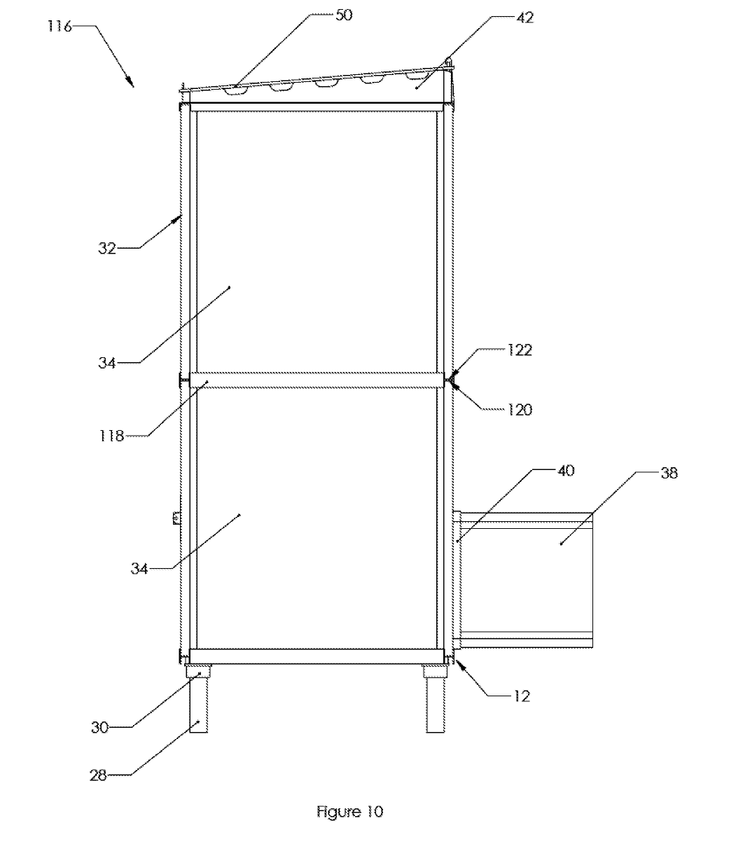

Likewise, FIG. 10 shows a side view of an expanded modular pet enclosure 116 according to the present invention showing two pet enclosures stacked on top of each other to create the expanded enclosure 116. The lower structure includes the base frame element 12, panel support means 32 and wall panels 34 are topped with a second base frame element 118 and are held within the lower channels 120 of the second base frame element 118. A second set of panel support means 32 and wall panels 34 are added on top of the second base frame element 118 and are held securely within the upper channels 122 of the second base frame element 118. These second set of panel support means 32 and wall panels 34 are then topped with the top frame element 42 and roof element 50.

While the particular herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed. All the publications cited are incorporated herein by reference in their entireties, including all published patents, patent applications, literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and sub generic groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A modular pet enclosure comprising:
(a) a base frame element containing a floor, wherein the base frame element has an upper face and a lower said upper and lower faces including a channel along at least a portion of said upper and lower faces;
(b) panel support means for containing a plurality of wall panels enclosing the sides of the enclosure, said panel support means being spaced at predetermined intervals and being held, at least in part, within the channels in the top face of the base frame element;
(c) a plurality of wall panels forming the sides of the enclosure, said wall panels being held in place by the panel support means and the channels in the upper face of the base frame element, wherein one of said wall panels comprises a tunnel connection panel, said tunnel connection panel including an opening and a connection flange surrounding said opening, said flange proving a base for the connection of a tunnel to the tunnel connection panel;
(d) a top frame element including an upper face, a lower face, sides and a channel along at least a portion or the lower face, said channel containing a top of each of the panel support means and wall panels, wherein one side of the upper face of the top frame element is higher than the opposing side, thereby creating a slant to the upper face of the top frame element;
(e) a roof element attached to and covering the upper face of the top frame element;
(f) a open-ended tunnel having a first end and a second end, said first end being attached to the connection flange of the tunnel connection panel and the second end being attached to a mounting flange, said dwelling flange being capable of attachment to an opening within the dwelling; and
(g) two or more adjustable legs attached to the lower face of the base frame element, said legs being adjustable in length to allow for the stable placement of the modular pet enclosure on the ground.

2. The modular pet enclosure of claim 1 wherein the sides of the top frame element contain a plurality of ventilation openings,

3. The modular pet enclosure of claim 1 wherein one or more of the wall panels are of differing size.

4. The modular pet enclosure of claim 1 wherein a side panel includes a door, said door being attached to open and close and including a latch to maintain the door in a closed position.

5. The modular pet enclosure of claim 1 wherein the roof element is attached to the top frame element with one or more hinges and includes a locking mechanism intersecting with the roof element to securely maintain the roof element in a closed position relative to the top frame element,

6. The modular pet enclosure of claim 1 wherein the floor contains a plurality of openings, thereby providing ventilation to the enclosure while containing and safeguarding a pet within the enclosure,

7. The modular pet enclosure of claim 1 wherein the mounting flange attached to the second end of the open-ended tunnel is connected to a pet door imposed within an opening in the dwelling.

8. The modular pet enclosure of claim 1 wherein two or more base frame elements are interconnected to form a larger expanded base frame and thereby an expanded modular pet enclosure.

9. The modular pet enclosure of claim 1 wherein the wall panels are inserted into the channels on the lower face of a second base frame element, and wherein the channels on the upper face of the second frame element contain a second set of panel support means and a second set of wall panels, topped by the top frame element and the roof element, resulting in a two storied modular pet enclosure.

10. A method of attaching the modular pet enclosure of claim 1 to an opening in a dwelling comprising:
(a) moving the modular pet enclosure to a predetermined orientation and location with respect to the opening in the residence;
(b) adapting the length and orientation of the open-ended tunnel as desired; and
(c) attaching the open end of the mounting flange affixed to the second end of the open-ended tunnel to the opening in the dwelling, wherein the open end of the mounting flange is sized and affixed.

11. A kit comprising:
(a) a base frame element, a floor, a plurality of panel support means, a plurality of wall panels, a tunnel connection panel, a top frame element, a roof element and a plurality of adjustable legs;
(b) an open-ended tunnel for connecting said enclosure to a dwelling opening;
(c) means for removably connecting a first end of the open-ended tunnel to an opening in the tunnel connection panel; and
(d) means for removably connecting a second end of the open-ended tunnel to and opening in the dwelling.
